(19) United States
(12) Patent Application Publication
(10) Pub. No.: US 2012/0293409 A1
(43) Pub. Date: Nov. 22, 2012

(54) MOBILE DEVICE AND DISPLAY CONTROL METHOD

(75) Inventors: Saya Miura, Yokohama-shi (JP); Yuuki Wada, Yokohama-shi (JP)

(73) Assignee: KYOCERA CORPORATION, Kyoto (JP)

(21) Appl. No.: 13/575,793

(22) PCT Filed: Jan. 27, 2011
(86) PCT No.: PCT/JP2011/051662

§ 371 Date: Jul. 27, 2012

(30) Foreign Application Priority Data
Jan. 27, 2010 (JP) 2010-016055

(51) Int. Cl. G06F 3/01

(52) U.S. Cl. 345/156

(57) ABSTRACT

According to an aspect, a mobile device includes an input unit, a display unit, a storage unit, and a control unit. The input unit detects operation input. The display unit displays a standby screen. The storage unit stores a plurality of objects to be displayed on the standby screen. The objects are associated with at least one of shortcut information or character information and being allocated with group information for classifying the objects. The control unit for sets on the standby screen a plurality of divided regions to be divided on a group-by-group basis and causes the plurality of objects to be displayed in the divided regions corresponding to the respective groups to which the objects belong.

### CROSS-REFERENCE TO RELATED APPLICATION

This application is a National Stage of international application No. PCT/JP2011/051662 filed on Jan. 27, 2011 which designates the United States, and which is based upon and claims the benefit of priority from Japanese Patent Application No. 2010-016055, filed on Jan. 27, 2010.

### FIELD

The present disclosure relates to a mobile device including a display configured to display a standby screen and a display control method.

### BACKGROUND

Among numerous mobile devices, some include a display unit. For example, Patent Literature 1 discloses, as such a mobile device, a communication device configured to display a sticky label on a standby screen of the display unit of a mobile phone. The sticky label is registered through operation of a user.

### CITATION LIST

### Patent Literature

Patent Literature 1: Japanese Patent Application Laid-Open No. 2005-110059

### TECHNICAL PROBLEM

A limited number of sticky labels can be displayed in an easily viewable manner on a standby screen. With respect to the communication device of Patent Literature 1, registering sticky labels by more than this number may cause difficulty in viewing the standby screen.

For the foregoing reasons, there is a need for a mobile device and a display control method that allow objects, such as labels, to be displayed on a standby screen in an easily viewable manner.

### SUMMARY

According to an aspect, a mobile device includes: an input unit for detecting operation input; a display unit for displaying a standby screen; a storage unit for storing a plurality of objects to be displayed on the standby screen, the objects being associated with at least one of shortcut information or character information and being allocated with group information for classifying the objects; and a control unit for setting on the standby screen a plurality of divided regions to be divided on a group-by-group basis and causing the plurality of objects to be displayed in the divided regions corresponding to the respective groups to which the objects belong.

It may be possible that the control unit is configured to perform, in causing the display unit to display the standby screen, differentiating the display sizes of the plurality of objects on the group-by-group basis and/or changing the proportion of the sizes of the divided regions per region.

It may be possible that the storage unit is configured to store the divided regions in association with different time frames. It may also be possible that the control unit is configured to obtain current clock time and to cause any of the divided regions that corresponds to any of the time frames that contains the obtained current clock time to be displayed in a larger size than the divided regions of the other time frames.

It may be possible that the control unit is configured to obtain current clock time and to cause any of the objects that belongs to any of the groups in association with any of the time frames that contains the obtained current clock time to be displayed in a larger size than the objects belonging to the other groups.

It may be possible that the storage unit is configured to store as the time frames at least two of a morning time frame, a daytime frame, or a nighttime frame.

It may be possible that the storage unit is configured to store time frame information on the object-by-object basis, and the control unit is configured to decide groups to be associated with the objects based on the time frame information of the objects.

It may be possible that the control unit is configured to obtain the current clock time each time the display unit is caused to display the standby screen.

It may be possible that the control unit is configured to set the respective time frames for the objects based on an operation input on the input unit and to cause the storage unit to store the time frames to be thus set.

It may be possible that the storage unit is configured to store the objects with the character information and icon images contained therein, and the control unit is configured to cause, in case where any of the objects is to be displayed in a larger size than the objects belonging to the other groups, the display unit to display the object with at least the character information included therein, and to cause, in case where any of the objects is to be displayed in a smaller size than the objects belonging to the other groups, the display unit to display the icon image with the character information

It may be possible that the control unit is configured to select any of the objects to be displayed on the display unit based on an operation to be input on the input unit, and to cause any of the divided regions that contains the selected object to be displayed in a larger size than the other divided regions.

It may be possible that the input unit includes a number input unit for inputting a number, and the control unit is configured to switch the screen to be displayed on the display unit from the standby screen to a screen for displaying the number to be input via the standby screen, upon detection of operation on the number input unit with the display unit being displaying the standby screen.

It may be possible that the mobile device further includes a communication unit, and the control unit is configured to cause numbers to be input on the number input unit to be displayed as a telephone number on the screen for displaying the number, and to cause the communication unit to perform, upon input of operation for making a call, processing for making a call directed to the telephone number to be input.

It may be possible that the input unit includes a function invoker for invoking a specific function, and the control unit is configured to switch the screen to be displayed on the display unit from the standby screen to a screen of the function associated with the function invoker upon receiving operation on the function invoker with the display unit being displaying the standby screen.

According to another aspect, a display control method for use in a mobile device having an input unit for detecting operation input, a display unit for displaying a standby screen, and a storage unit for storing various information, the display control method comprising: storing objects with group information for classifying the objects allocated thereto, the objects being associated with at least one of shortcut information or character information; setting on the standby screen a plurality of divided regions divided on a group-by-group basis; and causing the plurality of objects to be displayed in the divided regions corresponding to the respective groups to which the objects belong.

### ADVANTAGEOUS EFFECTS OF INVENTION

The mobile device and the display control method according to the present invention allow object images, such as labels, to be displayed on a standby screen in an easily viewable manner.

### BRIEF DESCRIPTION OF DRAWINGS

FIG. 1 is a perspective view of the appearance of a mobile phone.

FIG. 2 is a block diagram illustrating functions of a control unit.

FIG. 3 is an explanatory diagram illustrating a standby screen.

FIG. 4 is a flowchart illustrating a series of processes to be executed by the control unit for registering an object.

FIG. 5A is an explanatory diagram illustrating a screen being displayed on a display unit when an object is to be registered.

FIG. 5B is an explanatory diagram illustrating the display unit that is displaying a dialogue image.

FIG. 5C is an explanatory diagram illustrating the display unit that is displaying an image informing completion of registration of an object.

FIG. 5D is an explanatory diagram illustrating a standby screen when the registration of an object has been completed.

FIG. 6A is a flowchart illustrating a procedure to be executed by the control unit for causing the display unit to display a standby screen.

FIG. 6B is a flowchart illustrating a series of processes to be executed by the control unit in a standby state for input of an operation on an input unit.

FIG. 7 is an explanatory diagram illustrating a standby screen in which a daytime region is enlarged.

FIG. 8 is an explanatory diagram illustrating the display unit that is displaying a divided region containing a cursor image in a larger size than the sizes for the other divided regions.

### DESCRIPTION OF EMBODIMENTS

The present invention is described in detail below with reference to the drawings. It should be noted that the present invention is not limited by the following description. The components in the following description includes ones that easily occurs to those skilled in the art, ones substantially identical, and ones encompassed within a so-called equivalent scope. In the following description, a mobile phone is exemplarily described as the mobile device, but the present invention is not restrictively applied to mobile phones. For example, the present invention is applicable to PHSs (Personal Handyphone Systems), PDAs (Personal Digital Assistants), portable navigation systems, portable computers, and gaming devices.

### Embodiments

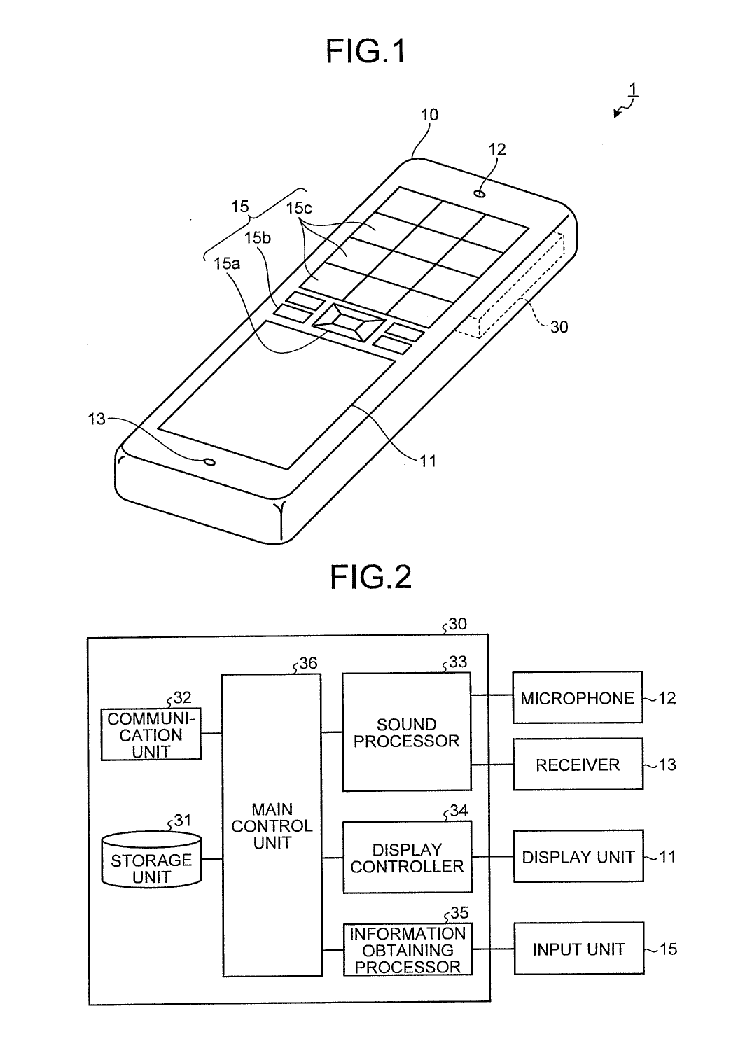

FIG. 1 is a perspective view illustrating the appearance of a mobile phone. A mobile phone 1 illustrated in FIG. 1 includes a housing 10, a display unit 11, a microphone 12, a receiver 13, an input unit 15, and a control unit 30. The housing 10 is, for example, configured by one case shape. The housing 10 is a so-called straight housing. The housing 10 may, for example, be configured by two constituent first and second housings. In this case, the housing 10 may be a sliding housing configured such that the first housing is slidable relative to the second housing or may be a folding housing configured such that the first housing is pivotal relative to the second housing. In other words, the configuration of the housing 10 is not limited.

The display unit 11, the microphone 12, the receiver 13, the input unit 15, and the control unit 30 are contained in the housing 10. The microphone 12, the receiver 13, the input unit 15, and the display unit 11 are electrically connected with the control unit 30. The control unit 30 is configured to include a CPU (Central Processing Unit), so as to perform integrated control over the overall operation of the mobile phone 1. The display unit 11 displays images based on signals received from the control unit 30. The display unit 11 displays a standby screen and other screens.

The standby screen is a screen in standby for reception of outgoing/incoming phone calls or for activation of application programs. In other words, the standby screen is a screen to be displayed until the screen is changed to a plurality of functional screens that the control unit 30 causes the display unit 11 to display, and also referred to as a desktop screen, a home screen, an idle screen, or a wallpaper. The functional screens are screens for providing the user with the functions of the mobile phone 1. Examples of the functions of the mobile phone 1 include a communication function with another mobile phone device, an email transmission/reception function, a photographing function to be performed by a built-in camera of the mobile phone 1, audiovisual function, etc. The user may set in advance an image to his/her taste or a condition display such as a clock as a standby screen.

The control unit 30 causes the display unit 11 to display the standby screen upon start of power supply to itself (the control unit 30) or return from the standby mode. The control unit 30 may cause the display unit 11 to display a startup screen containing an image of a company mark of the manufacturer or a startup image, between the start of power supply to itself (the control unit 30) and the display of the standby screen. Upon input for a switching operation to a functional screen on the input unit 15 to be described later with the standby screen being displayed on the display unit 11, the control unit 30 performs switch of the screen from the standby screen to the functional screen corresponding to the switching operation input on the input unit 15.

The microphone 12 converts sound into electrical signals. The control unit 30 obtains the sound converted to electrical signals from the microphone 12. The receiver 13 converts the electrical signals outputted from the control unit 30 into sound for output. The input unit 15 is provided, for example, in the form of buttons exposed on the outside of the housing 10. The input unit 15 is operated by the user of the mobile phone 1. The input unit 15 includes a directional button 15a, various functions invoking buttons 15b serving as a function invoker, and a number input buttons 15c serving as a number input unit. The directional button 15a is a button for moving a cursor to be displayed by the display unit 11. The various functions invoking buttons 15b are buttons for calling up functions such as the email transmission/reception function, the photographing function provided by a built-in camera of the mobile phone 1, and audiovisual function. The number input buttons 15c are buttons for inputting numbers. The number input buttons 15c are used for input of a telephone number in starting a voice call. The control unit 30 obtains operation input on the input unit 15 by the user.

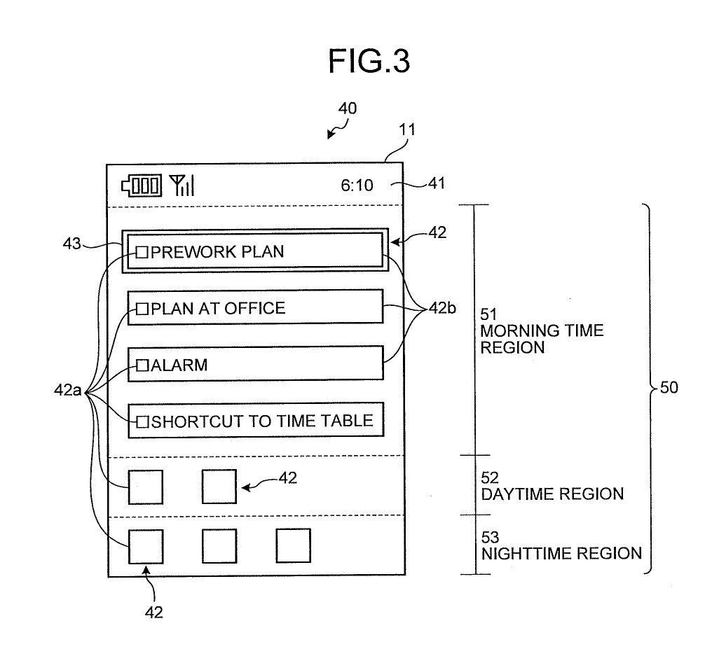

FIG. 2 is a block diagram illustrating functions of the control unit. The control unit 30 may be one device for implementing the functions illustrated in FIG. 2, or alternatively, may be such that a plurality of devices for individually implementing the functions illustrated in FIG. 2 are electrically connected to each other. The control unit 30 implements the functions of a storage unit 31, a communication unit 32, a sound processor 33, a display controller 34, an information obtaining processor 35, and a main control unit 36. The storage unit 31 stores series of processes (computer programs) to be executed by the control unit 30 and also stores information to be used for execution of the series of processes. The communication unit 32 establishes communication with another electronic device. Specifically, the communication unit 32 transmits emails composed by the user, receives emails sent from another mobile phone, and transmits and receives sound data for voice calls.

The sound processor 33 obtains signals from the microphone 12 and outputs signals to the receiver 13. Specifically, the sound processor 33 obtains from the microphone 12 sound data that the microphone 12 has converted to electrical signals. The sound processor 33 outputs signals to the receiver 13 and causes the receiver 13 to output sound. The display controller 34 generates images to be displayed by the display unit 11.

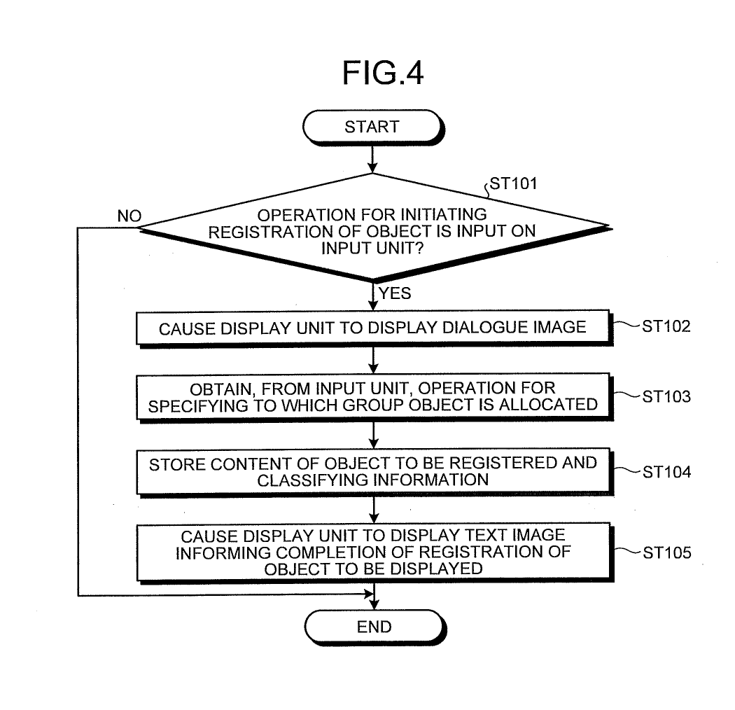

FIG. 3 is an explanatory diagram illustrating a standby screen. As illustrated in FIG. 3, images to be displayed on the display unit 11 under the control of the display controller 34 illustrated in FIG. 2 include a background image 41 (so-called wallpaper) serving as the standby screen, object images 42, and a cursor image 43. As illustrated in FIG. 3, the display controller 34 causes the display unit 11 to display images such that the object images 42 and the cursor image 43 are arranged on the background image 41. The object images 42 may be constituted by icon images 42a, or may include icon images 42a and text images 42b.

The icon image 42a is, for example, an image for representing the kind of an object by a picture. The text image 42b is an image for describing the summary of an object by a text. The object herein is associated with at least one of shortcut information for executing various application programs, or character information (note information). Such an object is referred to as “petamemo” (registered trademark)” in some cases. The cursor image 43 is, for example, an image of a frame enclosing an object image 42. The cursor image 43 may be at least an identifier of an object image 42 from among a plurality of object images 42. For example, the cursor image 43 may also be an image of an arrow.

The information obtaining processor 35 obtains signals from the input unit 15. Specifically, the information obtaining processor 35 obtains operation that the user inputs on the input unit 15 as command signals. The main control unit 36 controls each of components from the storage unit 31 to the information obtaining processor 35 and also implements functions that are different from those of the components from the storage unit 31 to the information obtaining processor 35. For example, the main control unit 36 executes a series of processes (computer programs) stored on the storage unit 31 and performs processing operations for execution of the series of processes.

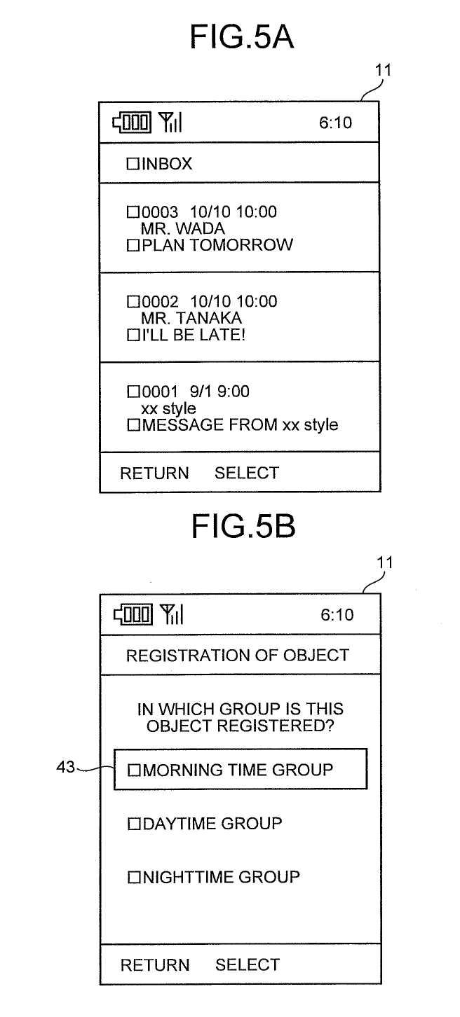

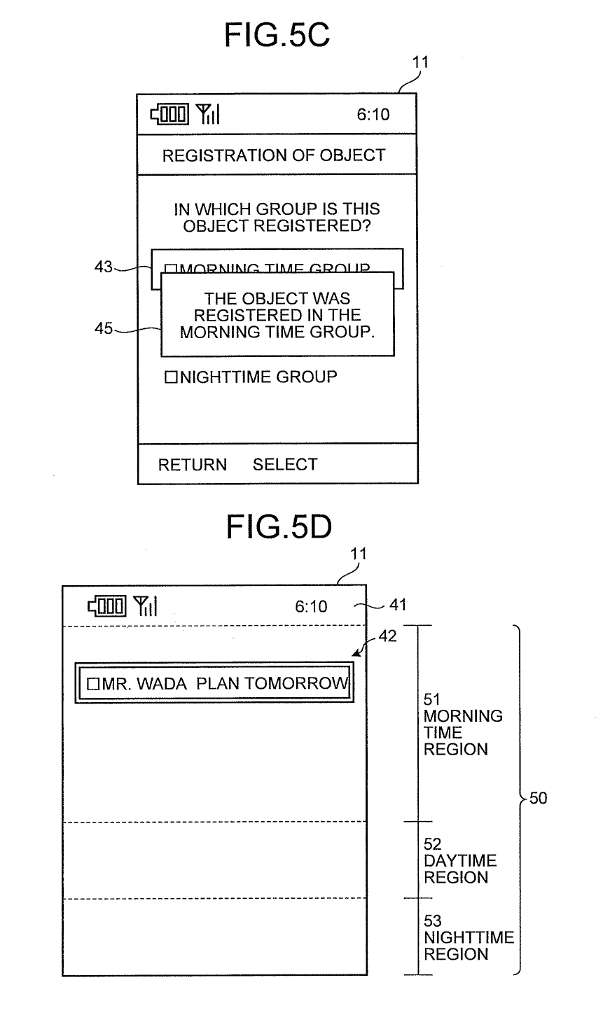

Next, description is given of the series of processes to be executed by the control unit 30 for registration of an object. FIG. 4 is a flowchart illustrating the series of processes to be executed by the control unit for registration of an object. FIG. 5A is an explanatory diagram illustrating a screen that is displayed on the display unit for registration of an object. FIG. 5B is an explanatory diagram illustrating the display unit that is displaying a dialogue image. FIG. 5C is an explanatory diagram illustrating the display unit that is displaying an image informing completion of registration of an object. FIG. 5D is an explanatory diagram illustrating a standby screen when registration of an object is completed.

In the following description, a case is exemplarily described in which the control unit 30 registers the text information of a received email as an object. To execute Step ST101, as illustrated in FIG. 5A, the display unit 11 displays a list of received emails. At Step ST101, the information obtaining processor 35 determines whether or not an operation for initiating registration of an object has been input on the input unit 15. For example, the input unit 15 includes a button for use in registration of objects, and the information obtaining processor 35 determines whether or not the button has been pressed. The button may be a button to be exclusively used for registration of objects, or may be a general-purpose button that is assigned another function in some cases. When the information obtaining processor 35 determines that an operation for initiating registration of an object is not input on the input unit 15 (No at Step ST101), the control unit 30 terminates execution of the series of processes.

When the information obtaining processor 35 determines that an operation for initiating registration of an object has been input on the input unit 15 (Yes at ST101), the control unit 30 causes the processing to proceed to Step ST102. As illustrated in FIG. 5B, at Step ST102, the display controller 34 causes the display unit 11 to display a dialogue image for inquiring to which group of a plurality of groups the object is to be allocated for registration. In the present embodiment, the plurality of groups are, for example, three groups of a morning time group, a daytime group, and a nighttime group. For example, the display controller 34 causes the display unit 11 to display as the dialogue image a text image reading, for example, “to which group is this object registered?” along with a text image representing the list of the plurality of groups. The user performs operation on the input unit 15 with reference to the dialogue image.

Subsequently, at Step ST103, the information obtaining processor 35 obtains signals from the input unit 15. Specifically, the information obtaining processor 35 receives from the input unit 15 an operation for specifying to which group of the plurality of groups the object is to be allocated.

Subsequently, at Step ST104, the storage unit 31 stores two kinds of information, i.e., the content of the object to be registered and classifying information therefor, in association with each other. The content of the object to be registered is, for example, a content corresponding to that which has been displayed on the display unit 11 at a point in time where the operation for initiating registration of the object is input on the input unit 15 at Step ST101. For example, in the case where text information (note information) is displayed on the display unit 11 at this point in time, the content of the object is this text information. In the case where a screen for activating an application program is displayed on the display unit 11 at this point in time, the content of the object is a shortcut for this application program. The classifying information is information that indicates to which group a specific object of a plurality of objects belongs to, which information has been input at Step ST103.

Subsequently, as illustrated in FIG. 5C, the display controller 34 causes the display unit 11 to display a text image 45 informing completion of registration of the object at Step ST105. The text image 45 is an image reading, for example, “the object was registered in the morning time group.” The display controller 34 may skip this Step ST105. After execution of Step ST105 (after execution of Step ST104 if Step ST105 is skipped), the control unit 30 terminates execution of the series of processes. The series of processes illustrated in FIG. 4 is executed by the control unit 30, and as illustrated in FIG. 5D, the registered object is displayed by the display unit 11 on the standby screen 40 as the object image 42.

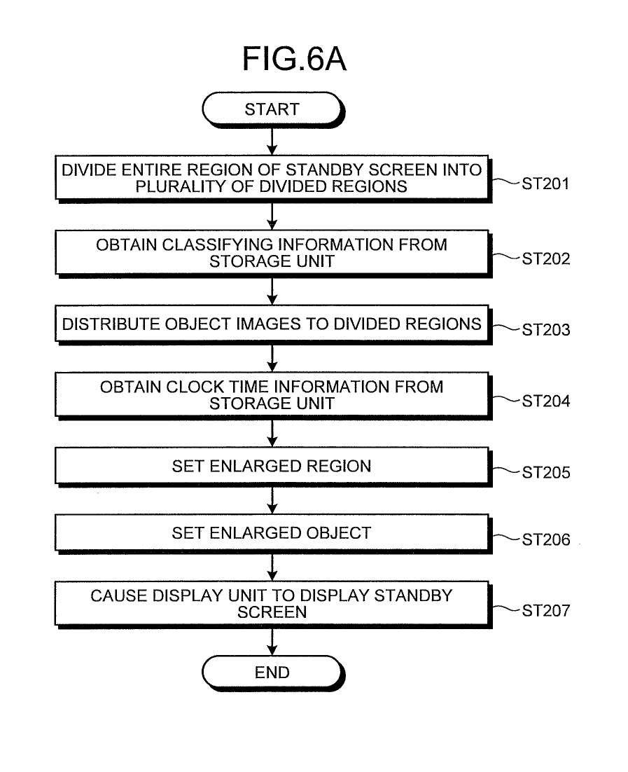

Next, description is given of a series of processes to be executed by the control unit 30 for causing the display unit 11 to display the standby screen 40. FIG. 6A is a flowchart illustrating a procedure to be executed by the control unit for causing the display unit to display the standby screen. At Step ST201, the main control unit 36 divides the entire region of the standby screen 40 displayed on the display unit 11 into, as illustrated in FIG. 3, a plurality of divided regions 50. The number of the divided regions 50 may be a preset constant number, or may be a number settable by the user. In the present embodiment, the main control unit 36 sets, for example, three divided regions 50.

In the present embodiment, the three divided regions 50 are a morning time region 51, a daytime region 52, and a nighttime region 53. The divided regions 50 are associated with time frames. For example, the time frames are set such that the morning time region 51 is set from three o'clock to nine o'clock, the daytime region 52 is set from nine o'clock to 17 o'clock, and the nighttime region 53 is set from 17 o'clock to three o'clock on the day after. These time frames may be fixed or may be altered by the user. The time frame(s) altered by the user is (are) stored on the storage unit 31. In this case, the mobile phone 1 may be configured to set the time frame(s) to a range as desired by the user.

Subsequently, at Step ST202, the main control unit 36 obtains from the storage unit 31 the classifying information associated with the objects, which information is stored on the storage unit 31. The classifying information is information that has been stored by the storage unit 31 at Step ST104 illustrated in FIG. 4 and indicates to which group of a plurality of groups, e.g., a morning time group, a daytime group, and a nighttime group, the registered object belongs. The morning time group is a group of objects to be displayed in the morning time region 51 illustrated in FIG. 3, the daytime group is a group of objects to be displayed in the daytime region 52, and the nighttime group is a group of objects to be displayed in the nighttime region 53. The groups are associated with time frames in the same manner as with the divided regions 50.

Subsequently, at Step ST203, the main control unit 36 distributes the object images 42 illustrated in FIG. 3 to the divided regions 50, respectively, based on the classifying information. For example, in the case where an object belongs to the morning time group, the main control unit 36 sets so as for the object image 42 that represents the object to be arranged in the morning time region 51. It is to be noted here that the main control unit 36 merely sets the position at which the object image 42 is to be arranged and does not cause the display unit 11 to display the object image 42.

Subsequently, at Step ST204, the main control unit 36 obtains clock time information from the storage unit 31. The clock time information is information indicating current clock time of the internal clock of the mobile phone 1. In the description below, the current clock time of the internal clock of the mobile phone 1 is simply referred to as current clock time. The main control unit 36 obtains clock time information from the storage unit 31 each time the series of processes illustrated in FIG. 6A is executed, namely, each time the display unit 11 displays the standby screen 40.

Subsequently, at Step ST205, the main control unit 36 sets as an enlarged region a divided region 50, of the plurality of divided regions 50, that is associated with the time frame containing the current clock time indicated by the clock time information, based on the clock time information obtained at Step ST204. The enlarged region is a region for which a larger area is secured as compared with the other divided regions 50. In FIG. 3, the morning time region 51 applies to the enlarged region. For example, in the case where the current clock time is 6:10, the display controller 34 sets, as illustrated in FIG. 3, the morning time region 51 that is associated with the time frame from three o'clock to nine o'clock, as the enlarged region.

Subsequently, at Step ST206, the main control unit 36 sets as an enlarged object an object that belongs to the group corresponding to the divided region 50, of the plurality of divided regions 50, that has been set as the enlarged region. The enlarged object is an object that has a larger display size than the objects that belong to the other groups. Specifically, the main control unit 36 specifies a group of the plurality of groups that is associated with the time frame containing the current clock time indicated by the clock time information, based on the clock time information obtained at Step ST204. Then, the main control unit 36 sets as the enlarged object an object that belongs to the group specified. For example, in the case where the current clock time is 6:10, the display controller 34 sets, as illustrated in FIG. 3, objects that belong to the morning time group that is associated with the time frame from three o'clock to nine o'clock, as enlarged objects.

In the present embodiment, the object images 42 descriptive of the enlarged objects include both icon images 42a and text images 42b. On the other hand, the other object images 42 are constituted by icon images 42a. The object images 42 to be arranged in the enlarged region are arranged in line along a longitudinal direction (a vertical direction) of the display unit 11. On the other hand, the object images 42 to be arranged in the other divided region 50 are arranged in a clustered manner in the direction (a horizontal direction) orthogonal to the longitudinal direction of the display unit 11.

Subsequently, at Step ST207, the display controller 34 causes the display unit 11 to display the standby screen 40 in such a manner that, as illustrated in FIG. 3, a larger area for the enlarged region, e.g., the morning time region 51 in the present embodiment, is secured as compared with the areas for the other divided regions 50 and the object images 42 to be arranged in the enlarged region are enlarged relative to the other object images 42.

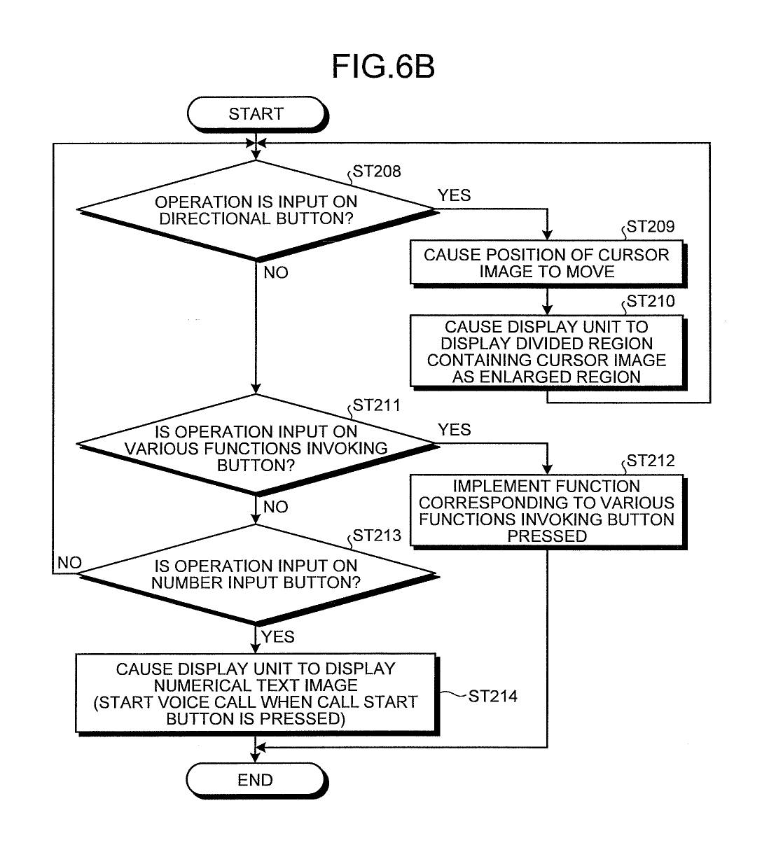

FIG. 7 is an explanatory diagram illustrating a standby screen in which the daytime region is enlarged. For example, in the case where the current clock time is 12:30, the main control unit 36 sets, at Step ST205 illustrated in FIG. 6A, the daytime region 52 as the enlarged region. At step ST206, the objects belonging to the daytime group are set as the enlarged objects. Then, as illustrated in FIG. 7, the display controller 34 causes the display unit 11 to display the standby screen 40 in such a manner that a larger area for the daytime region 52 is secured as compared with the areas for the other divided regions 50 and the object images 42 to be arranged in the daytime region 52 are enlarged relative to the other object images 42. after execution of Step ST207, the control unit 30 terminates the series of processes for displaying the standby screen 40.

Subsequently, the control unit 30 executes a series of processes to be described below with the standby screen 40 being displayed on the display unit 11. FIG. 6B is a flowchart illustrating the series of processes to be executed by the control unit in standby for reception of operation input on the input unit. At Step ST208, the information obtaining processor 35 determines whether or not an operation is received on the directional button 15a. When the information obtaining processor 35 determines that an operation is received on the directional button 15a (Yes at Step ST208), the control unit 30 causes the processing to proceed to Step ST209. At Step ST209, the display controller 34 causes the position of the cursor image 43 being displayed on the display unit 11 to move based on signals obtained by the information obtaining processor 35. For example, in the case where a down button of the directional button 15a is pressed on, the display controller 34 causes the cursor image 43 to move downward along the longitudinal direction of the display unit 11 (toward the user). Herein, the control unit 30 may, in response to the operation input on the directional button 15a, cause the cursor image 43 to move within the divided region 50 containing the cursor image 43, or alternatively, may cause the cursor image 43 to move to a divided region 50 that does not contain the cursor image 43.

In the case where the cursor image 43 is moved within the divided region 50 containing the cursor image 43 in response to the operation input on the directional button 15a, the control unit 30 causes, for example, the cursor image 43 to move in the following fashion. In the case illustrated in FIG. 3, the display controller 34 causes the cursor image 43 to move to the uppermost object image 42 in the morning time region 51 when the down button of the directional button 15a is pressed on with the cursor image 43 being in the object image 42 at the lowermost side (at the user side) in the morning time region 51. Specifically, the control unit 30 causes the cursor image 43 to revolve within the morning time region 51. In this mode, for example, the display controller 34 may also cause the cursor image 43 to move to a divided region 50 that does not contain the cursor image 43 when pressed is a button that is not the down button of the directional button 15a and is provided for causing the cursor image 43 to move to a divided region 50 other than the current divided region 50.

Meanwhile, in the case where the cursor image 43 is also moved to a divided region 50 that does not contain the cursor image 43 in response to an operation input on the directional button 15a, the control unit 30 causes, for example, the cursor image 43 to move in the following fashion. When the down button of the directional button 15a is pressed on with the cursor image 43 being at the object image 42 at the lowermost side (at the user side) in the morning time region 51, the control unit 30 causes the cursor image 43 to move to the uppermost object image 42 in the daytime region 52.

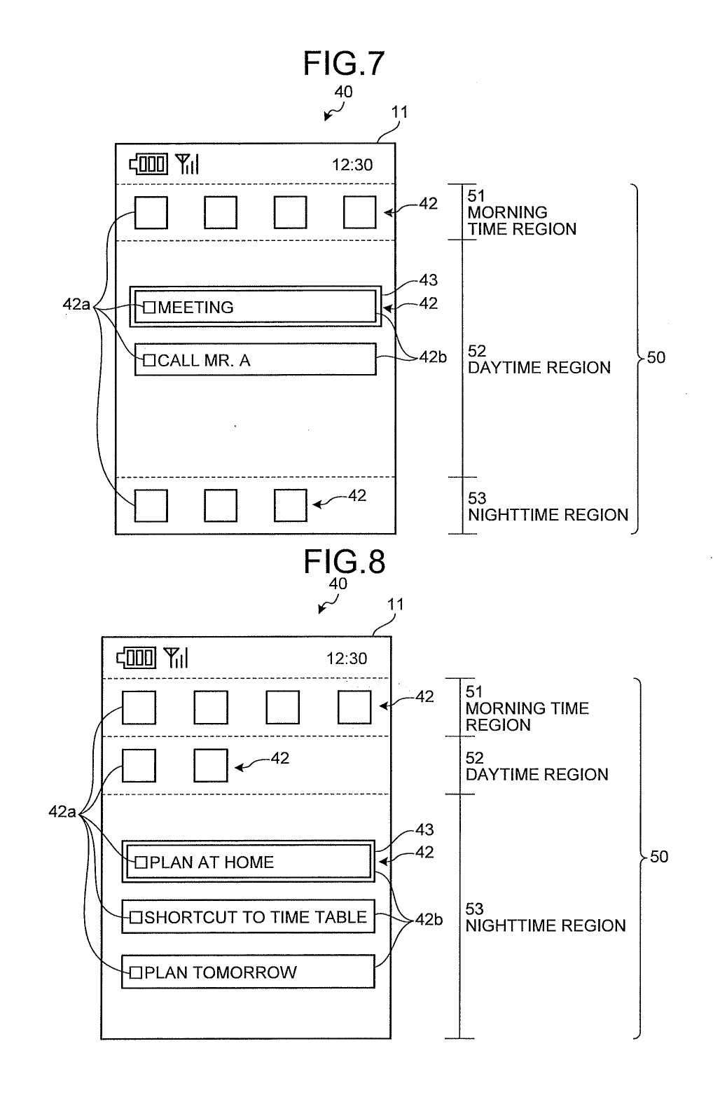

FIG. 8 is an explanatory diagram illustrating the display unit that displays a divided region containing the cursor image in an enlarged manner relative to the other divided regions. Subsequently, at Step ST210, the display controller 34 causes, as illustrated in FIG. 8, the display unit 11 to display a divided region 50 containing the cursor image 43, e.g., the nighttime region 53 in FIG. 8, as the enlarged region, such that this region is displayed being enlarged relative to the other divided regions 50. Further, the display controller 34 causes the display unit 11 to display an object image 42 to be arranged in the divided region 50 containing the cursor image 43 so as to be enlarged relative to the object images 42 to be arranged in the other divided regions 50. Specifically, the display controller 34 causes the display unit 11 to display the object image 42 that is arranged in the divided region 50 containing the cursor image 43 so as to include two kinds of images of the icon image 42a and the text image 42b. After execution of Step ST210, the control unit 30 causes the processing to return to Step ST208.

When the information obtaining processor 35 determines that an operation is not input on the directional button 15a (No at Step ST208) at Step ST208, the control unit 30 causes the processing to proceed to Step ST211. At Step ST211, the information obtaining processor 35 determines whether or not an operation has been input on a various functions invoking button 15b. When the information obtaining processor 35 determines that an operation has been input on a various functions invoking button 15b (Yes at Step ST211), the control unit 30 causes the processing to proceed to Step ST212. At Step ST212, the control unit 30 implements the function corresponding to the various functions invoking button 15b pressed at Step ST211.

For example, when an email button is pressed as the various functions invoking button 15b, the control unit 30 implements an electronic mail function. Specifically, the display controller 34 causes the display unit 11 to display a screen for composing an email. Then, the display controller 34 causes the display unit 11 to display a text image corresponding to the text input, according to the operation input on the input unit 15. Subsequently, when an email transmission button is pressed on, the communication unit 32 transmits the email. After execution of Step ST212, the control unit 30 terminates the series of processes.

When the information obtaining processor 35 determines that an operation is not input on any various functions invoking button 15b (No at Step ST211), the control unit 30 causes the processing to proceed to Step ST213. Subsequently, at Step ST213, the information obtaining processor 35 determines whether or not an operation has been input on a number input button 15c. When the information obtaining processor 35 determines that an operation is not input on any number input button 15c (No at Step ST213), the control unit 30 causes the processing to return to Step ST208. When the information obtaining processor 35 determines that an operation has been input on a number input button 15c (Yes at Step ST213), the control unit 30 causes the processing to proceed to Step ST214. At Step ST214, the display controller 34 causes the display unit 11 to display a numerical text image according to the operation input on the input unit 15. When a call start button is pressed on in this state, the communication unit 32 sets a voice call to start. After execution of Step ST214, the control unit 30 terminates execution of the series of processes.

With the above configuration, the storage unit 31 of the mobile phone 1 stores two kinds of information, i.e., objects that are to be displayed on the standby screen 40 and contain at least one of shortcut information or character information, and information on groups (classifying information) for classifying the objects. The control unit 30 of the mobile phone 1 sets a plurality of divided regions 50 configured by the region of the standby screen 40 being divided into separate groups. Then, the control unit 30 of the mobile phone 1 causes an object to be displayed in a divided region 50 corresponding to the group to which that object belongs. Thus, the mobile phone 1 is configured to cause the display unit 11 to display a plurality of object images 42 being classified into a plurality of divided regions 50. Hence, the mobile phone 1 displays object images 42 on the standby screen 40 in an easily viewable manner.

In the present embodiment, the control unit 30 executes, in causing the display unit 11 to display the standby screen 40, both the procedures of changing the display sizes of the objects per group and of changing the proportion of the sizes of the divided regions 50 on the basis of the plurality of divided regions 50. The control unit 30 however may execute at least one of the above-described two procedures. Thus, the mobile phone 1 may be configured to reduce, for example, the display size of an object to be arranged in a divided region with a lower degree of importance as compared to the display size of an object to be arranged in a divided region with a higher degree of importance. Further, the mobile phone 1 may be configured to, for example, reduce the size of a divided region with a lower degree of importance relative to a divided region with a higher degree of importance. As described above, the mobile phone 1 displays object images 42 on the standby screen 40 in an easily viewable manner.

Further, in the mobile phone 1, the storage unit 31 stores the divided regions 50 in association with time frames, respectively, and the control unit 30 obtains clock time information and causes a divided region 50 at a time frame containing the obtained clock time information to be displayed larger than the divided regions 50 at the other time frames. A tendency is seen that the divided region 50 at the time frame containing the clock time information applies to the above-described divided region with a higher degree of importance. Thus, with the mobile phone 1, the user does not have to specify the degree of importance of the divided regions. Accordingly, the mobile phone 1 is so adapted that an object with a deeper relationship with the current clock time is displayed with emphasis, on the display unit 11. Hence, the mobile phone 1 displays object images 42 on the standby screen 40 in an easily viewable manner.

In the mobile phone 1, the storage unit 31 stores the groups in association with time frames, and the control unit 30 obtains clock time information and causes an object that belongs to the group associated with a time frame containing the obtained clock time information to be displayed larger than the objects that belong to the other groups. A tendency is seen that the group at the time frame containing the clock time information applies to the above-described group with a higher degree of importance. Thus, the mobile phone 1 may skip the task for the user to specify the degree of importance of the groups. The mobile phone 1 is so adapted to display the object with a deeper relationship with the current clock time in an enhanced manner on the display unit 11. Hence, the mobile phone 1 displays object images 42 on the standby screen 40 in an easily viewable manner.

The control unit 30 obtains clock time information each time the display unit 11 is caused to display the standby screen 40. Thus, the mobile phone 1 is configured to enable update of, each time the display unit 11 is caused to display the standby screen 40, the divided region 50 to be displayed being enlarged relative to the other divided regions 50, as well as update of the object image(s) 42 to be displayed in an enlarged display size as compared to the other object images 42.

The control unit 30 causes the display unit 11 to display the text images 42b that represent at least a portion of character information, as well as the icon images 42a. Thereby, the display unit 11 is configured to display the object in a larger display size than the objects belonging to the other groups. The control unit 30 may also be configured to cause the display unit 11 to display only the icon images 42a. Thereby, the display unit 11 is configured to display the object in a smaller display size than the objects belonging to the other groups.

The control unit 30 causes a cursor to move, which cursor indicates an object selected from among the objects displayed on the display unit 11, based on the operation input on the input unit 15, such that a divided region 50 containing the selected object is displayed larger than the other divided regions 50. Thus, the mobile phone 1 is configured to display, as compared to the other divided regions 50, a divided region 50 containing an object of which the user desires detailed display in an enlarged manner, which allows as a result the mobile phone 1 to display object images 42 on the standby screen 40 in an easily viewable manner.

The control unit 30 changes the screen to be displayed on the display unit 11 to a screen for displaying a number input via the standby screen 40 when it is detected that a number input button 15c is operated with the display unit 11 displaying the standby screen 40. Further, the control unit 30 causes numbers input by using number input buttons 15c, such that the values are displayed on the screen for displaying the numbers in the form of a telephone number, and upon input of an operation for making a call, processing for making a call directed to the input telephone number is performed by the communication unit 32. Thus, the mobile phone 1 is configured to provide the voice call function to the user.

The control unit 30 switches the screen to be displayed on the display unit 11 from the standby screen 40 to a screen of a function associated with a various functions invoking button 15b when the various functions invoking button 15b is operated with the display unit 11 displaying the standby screen 40. Thus, the mobile phone 1 is configured to provide various functions of the mobile phone 1 to the user.

In the present embodiment, the plurality of groups for classifying objects include the morning time group, the daytime group, and the nighttime group. In other words, in the present embodiment, the control unit 30 sets the groups by dividing one day by hours. The control unit 30 however may, for example, set the groups by dividing one week by the days of a week. In this case, the display unit 11 provides divided regions 50 corresponding to the days of a week on the standby screen 40. The control unit 30 may also set the groups by dividing one week by weekdays and holidays. In this case, the display unit 11 provides divided regions 50 that correspond to weekdays and divided regions 50 that correspond to holidays, on the standby screen 40.

In this manner, the control unit 30 sets a plurality of divided regions 50 on the standby screen 40 based on a principle of iteration on the time axis and sets groups corresponding to the divided regions 50. Thus, the mobile phone 1 is configured to display object images 42 indicating matters that the user makes it a rule on the standby screen 40 by grouping. The mobile phone 1 may also preferentially display an important object image 42 at a certain point in time in an enhanced manner on the standby screen 40. Hence, the mobile phone 1 displays object images 42 on the standby screen 40 in an easily viewable manner.

The control unit 30 may set one object in such a manner that the object belongs to a plurality of groups. In this case, the display controller 34 allows for selection of a plurality of groups on the screen illustrated in FIG. 5B. In the case where the object belongs to two groups, the enlarged region is the region that the display controller 34 causes the object image 42 to be displayed therein. For example, in the case where the current clock time is any time as from three o'clock to nine o'clock, the morning time region 51 is the region in which the display controller 34 causes an object image 42 to be displayed, of which object image the time frame is set from seven o'clock to twelve o'clock. Then, when the current clock time is time as from nine o'clock, the daytime region 52 is the region that the display controller 34 causes the object image 42 to be displayed therein.

The control unit 30 may also allow the user to set time frames per object to be registered. Specifically, the display controller 34 first causes the display unit 11 to display, in place of the screen illustrated in FIG. 5B, a text image reading, for example, “set time frames to the objects”. The user inputs operation for setting the time frames by means of the input unit 15 with reference to this screen. Then, the information obtaining processor 35 obtains signals from the input unit 15 and associates the time frames with the objects based on the signals.

In this case, the main control unit 36 distributes the objects to the groups based on the time frames. For example, consider a case in which the time frame for the objects is from seven o'clock to twelve o'clock. In this case, the main control unit 36 allocates the objects to both the morning time group and the daytime group. In this manner, the display controller 34 causes the object images 42 corresponding to the registered objects to be displayed both in the morning time region 51 and the daytime region 52. As described in the above manner, the mobile phone 1 displays objects image 42 still more suitably on the standby screen 40.

The control unit 30 may also be so configured to set the time frames of the groups in such a manner as to partly overlap each other. For example, the control unit 30 may be so configured to set the time frames of the groups such that the morning time group is from three o'clock to ten o'clock, the daytime groups is from nine o'clock to 18 o'clock, and the nighttime group is from 17 o'clock to three o'clock. In this case, if the current clock time is contained in two time frames, the control unit 30 sets the two divided regions 50 containing the current clock time as enlarged regions, or alternatively, an object that is included in two groups containing the current clock time as an enlarged object.

The display controller 34 may change the order of the plurality of divided regions 50 on the standby screen 40. The display controller 34 arranges, for example, the divided region 50 corresponding to the time frame containing the current clock time in a central portion of the screen. For example, in the case where the current clock time is seven o'clock, the display controller 34 arranges the morning time region 51 in a central portion of the screen. Specifically, the display controller 34 arranges the morning time region 51 between the daytime region 52 and the nighttime region 53. For example, when the current clock time is any time as from 17 o'clock, the display controller 34 arranges the nighttime region 53 between the morning time region 51 and the daytime region 52.

Thus, the mobile phone 1 is configured to arrange the divided region 50 corresponding to the time frame containing the current clock time in a central portion of the screen for enhancement. As a result, the mobile phone 1 displays object images 42 on the standby screen 40 in an easily viewable manner. It is to be noted that some users prefer an arrangement in which the divided regions 50 are arranged according to the time sequence. In this case, the mobile phone 1 may array the divided regions 50 in the order of the morning time region 51, the daytime region 52, and the nighttime region 53, such that the nighttime region 53 takes a position closest to the user side. Thus, the control unit 30 may is configured to allow the user to set the manner of arrangement of the plurality of divided regions 50. Thus, the mobile phone 1 displays object images 42 on the standby screen 40 in an even more suitably viewable manner.

### INDUSTRIAL APPLICABILITY

As described above, the mobile device and the display controlling method according to the present invention are useful in mobile devices and display controlling methods for displaying object images on a standby screen, and is especially suitable for reducing difficulty in viewing the standby screen.

1. A mobile device, comprising:
an input unit for detecting operation input;
a display unit for displaying a standby screen;
a storage unit for storing a plurality of objects to be displayed on the standby screen, the objects being associated with at least one of shortcut information or character information and being allocated with group information for classifying the objects; and
a control unit for setting on the standby screen a plurality of divided regions to be divided on a group-by-group basis and causing the plurality of objects to be displayed in the divided regions corresponding to the respective groups to which the objects belong.

2. The mobile device according to claim 1, wherein
the control unit is configured to perform, in causing the display unit to display the standby screen, differentiating the display sizes of the plurality of objects on the group-by-group basis and/or changing the proportion of the sizes of the divided regions per region.

3. The mobile device according to claim 2, wherein
the storage unit is configured to store the divided regions in association with different time frames.

4. The mobile device according to claim 3, wherein
the control unit is configured to obtain current clock time and to cause any of the divided regions that corresponds to any of the time frames that contains the obtained current clock time to be displayed in a larger size than the divided regions of the other time frames.

5. The mobile device according to claim 3, wherein
the control unit is configured to obtain current clock time and to cause any of the objects that belongs to any of the groups in association with any of the time frames that contains the obtained current clock time to be displayed in a larger size than the objects belonging to the other groups.

6. The mobile device according to claim 3, wherein
the storage unit is configured to store as the time frames at least two of a morning time frame, a daytime frame, or a nighttime frame.

7. The mobile device according to claim 3, wherein
the storage unit is configured to store time frame information on the object-by-object basis, and
the control unit is configured to decide groups to be associated with the objects based on the time frame information of the objects.

8. The mobile device according to claim 3, wherein
the control unit is configured to obtain the current clock time each time the display unit is caused to display the standby screen.

9. The mobile device according to claim 7, wherein
the control unit is configured to set the respective time frames for the objects based on an operation input on the input unit and to cause the storage unit to store the time frames to be thus set.

10. The mobile device according to claim 3, wherein
the storage unit is configured to store the objects with the character information and icon images contained therein, and
the control unit is configured to cause, in case where any of the objects is to be displayed in a larger size than the objects belonging to the other groups, the display unit to display the object with at least the character information included therein, and
to cause, in case where any of the objects is to be displayed in a smaller size than the objects belonging to the other groups, the display unit to display the icon image with the character information excluded.

11. The mobile device according claim 3, wherein
the control unit is configured to select any of the objects to be displayed on the display unit based on an operation to be input on the input unit, and
to cause any of the divided regions that contains the selected object to be displayed in a larger size than the other divided regions.

12. The mobile device according to claim 1, wherein
the input unit includes a number input unit for inputting a number, and
the control unit is configured to switch the screen to be displayed on the display unit from the standby screen to a screen for displaying the number to be input via the standby screen, upon detection of operation on the number input unit with the display unit being displaying the standby screen.

13. The mobile device according to claim 12, further comprising a communication unit, wherein
the control unit is configured to cause numbers to be input on the number input unit to be displayed as a telephone number on the screen for displaying the number, and to cause the communication unit to perform, upon input of operation for making a call, processing for making a call directed to the telephone number to be input.

14. The mobile device according to claim 12, wherein
the input unit includes a function invoker for invoking a specific function, and
the control unit is configured to switch the screen to be displayed on the display unit from the standby screen to a screen of the function associated with the function invoker upon receiving operation on the function invoker with the display unit being displaying the standby screen.

15. A display control method for use in a mobile device having an input unit for detecting operation input, a display unit for displaying a standby screen, and a storage unit for storing various information, the display control method comprising:
storing objects with group information for classifying the objects allocated thereto, the objects being associated with at least one of shortcut information or character information;
setting on the standby screen a plurality of divided regions divided on a group-by-group basis; and
causing the plurality of objects to be displayed in the divided regions corresponding to the respective groups to which the objects belong.
